(19) United States
(12) Patent Application Publication
(10) Pub. No.: US 2026/0284696 A1
(43) Pub. Date: Sep. 24, 2026

(54) NOZZLE DEVICE FOR APPLYING A VISCOUS MATERIAL

(71) Applicant: Atlas Copco IAS GmbH, Bretten (DE)

(72) Inventors: Heiko BITZEL, Karlsruhe (DE); Adrian JENZ, Karlsruhe (DE); Simon VOGEL, Bruchsal (DE)

(73) Assignee: Atlas Copco IAS GmbH, Bretten (DE)

(21) Appl. No.: 18/996,040

(22) PCT Filed: Jul. 25, 2023
(86) PCT No.: PCT/EP2023/070594

§ 371 Date: Jan. 17, 2025

(30) Foreign Application Priority Data
Aug. 4, 2022 (DE) 10 2022 119 669.0

(51) Int. Cl. B05C 5/02

(52) U.S. Cl. CPC B05C 5/027

(57) ABSTRACT

A nozzle device for applying a viscous material to workpieces includes a nozzle body which has a central part having a front face, and two side parts protruding at a distance from each other from the central part. Each of the side parts has a transverse side adjoining the front face and extending transversely thereto. The two transverse sides face each other, and an outlet opening for the viscous material is arranged in each of the transverse sides. A material channel through the nozzle body runs to each outlet opening and connects the outlet openings to a material inlet opening of the nozzle body. The nozzle body has a main body and a cover body releasably fastened to the main body, wherein the material channels are at least in part delimited both by a boundary face on the main body and by a boundary face on the cover body.

The invention relates to a nozzle device for applying a viscous material to workpieces, in accordance with the preamble of claim 1.

Such a nozzle device is known, for example, from EP 3 548 190 B1. Using such nozzle devices, it is possible, in particular, to coat two surfaces of a workpiece, which face away from one another, with viscous material at the same time, in that the workpiece is arranged between the side parts of the nozzle body in such a manner that the two surfaces to be coated, which face away from one another, face the transverse sides, for example on a standing flange of a motor vehicle body. The nozzle device is then moved relative to the workpiece, in particular by means of an industrial robot, wherein an end face of the workpiece that connects the surfaces to be coated with one another faces the end face of the nozzle device. It is a disadvantage of previously known nozzle devices of the type stated initially that they are difficult to produce, due to their complicated geometry.

It is therefore the task of the invention to further develop a nozzle device of the type stated initially, in such a manner that it is easier to produce.

This task is accomplished, according to the invention, by means of a nozzle device having the characteristics of claim 1. Advantageous further developments of the invention are the object of the dependent claims.

The invention is based on the idea of configuring the nozzle body in multiple parts, so as to be able to introduce the material channels and the exit openings into the nozzle body more easily. In particular, the possibility exists of milling the material channels into the main body and/or the cover body of the nozzle body section by section, and then joining the main body and the cover body together, in particular by means of screw connections, in such a manner that the material channels are delimited, section by section, both by a delimitation surface on the main body and also by a delimitation surface on the cover body. This is easier to implement, in terms of production technology, than drilling the material channels into the nozzle body in their entirety. Furthermore it is possible to implement more complicated geometries for the material channels, so that, for example, lower pressure losses occur due to greater cross-sections of the material channels. Because of the multiple parts of the nozzle device, the material channels can be optimized in terms of flow technology. In particular, dead spaces can be minimized or avoided. The assembly of the nozzle device can also be made easier.

In the end face, a further exit opening for the viscous material can be arranged, which opening is connected to the material entry opening by means of a further material channel. By way of the further exit opening, the viscous material can then be applied to the end face of the workpiece, which faces the end face of the central part, so that the workpiece can be simultaneously coated on three sides that border on one another in pairs. Furthermore, it is preferred that the exit openings are arranged with mirror symmetry with reference to a plane of symmetry, wherein the plane of symmetry can run, in particular, through the further exit opening. The nozzle device can then apply the viscous material symmetrically to the two surfaces of the workpiece, which face away from one another. In other application cases, an asymmetrical arrangement of the exit openings can also be preferred.

It is practical if a central channel extends, starting from the material entry opening, through the nozzle body, and opens into the side material channels and, if applicable, into the central further material channel. For this purpose, it is advantageous if a distributor point is arranged at the transition between the central channel and the material channels, and, if applicable, the further material channel. The central channel and the further material channel preferably have a common center longitudinal axis, so that the further material channel represents an extension of the central channel.

It is practical if the central channel is arranged in the main body. In this regard, the main body can have multiple parts, in particular, and can have a base for fastening it to a nozzle support, as well as an end piece that is releasably connected to the base, wherein the central channel, in particular, runs through the base and branches off into the material channels, and, if applicable, the further material channel, at the distributor point arranged in the end piece. Furthermore it is preferred that the exit openings and/or the material entry openings and/or the wide exit opening and/or the further material channel are arranged in or on the main body.

It is practical if the material channels each have a first section and a second section that follows the first section in the flow direction of the material, wherein the first sections are delimited, in each instance, by the delimitation surfaces on the main body and on the cover body, while the second sections are delimited, in each instance, only by the main body. In this way, it is possible to mill the first sections into the main body and/or into the cover body during the production of the nozzle device, and to subsequently drill the second sections into the main body, in particular proceeding from the first sections.

It is practical if the cross-section of the central channel is greater than the sum of the cross-sections of the exit openings and, if applicable, the further exit opening. At the branching point, there is therefore a reduction in cross-section. In this regard, it is preferred that the cross-section of the central channel is at least twice, preferably at least three times, and ideally at least four times as great as the sum of the cross-sections of the exit openings and, if applicable, of the further exit opening. The exit openings and, if applicable, the further exit opening are furthermore preferably configured to be identical. In this regard, an embodiment as what is called a flat-stream nozzle is preferred, in which the exit openings and, if applicable, the further exit opening each have a rectangular cross-section, the length of which is at least five times and preferably at least ten times as great as its width. In this regard, it is practical to measure the length at the exit openings in a direction that extends away from the end face of the central part, and it is practical to measure the length of the further exit opening in a direction that extends from one transverse side to the other. By means of this measure, material application in a very wide material bead is possible.

It is advantageous if the exit openings and, if applicable, the further exit opening are each arranged in a nozzle insert that is connected to the nozzle body. The nozzle inserts are inserted into the nozzle body and preferably fixed in place on it by means of a glued connection. In particular in the case that abrasive materials are being discharged, the wear at the exit openings is great, so that it is advantageous if the nozzle inserts are produced from a low-wear material. It is practical if the nozzle inserts are produced from hard metal, at least on the inner side that faces the viscous material, in order to reduce friction wear. In this regard, a hard metal is understood to be a metal/matrix composite material in which hard substances present in particle form are held together by means of a matrix made of metal. Hard substances that can be used are, in particular, metal carbides or metal nitrides, such as, for example, tungsten carbide, titanium carbide, titanium nitride, niobium carbide, tantalum carbide or vanadium carbide.

It is practical if a sealing element is arranged between the main body and the cover body, which element forms an edge around the delimitation surfaces on the main body and on the cover body that delimit the material channels. In particular, an elastomer sealing element or a sealing element made of metal can be used, which element then prevents an undesirable exit of material between the main body and the cover body. However, it is also possible to achieve the seal by means of planar contact of the metal surfaces of the main body and of the cover body against one another.

In the following, the invention will be explained in greater detail using an exemplary embodiment shown schematically in the drawing. The figures show:

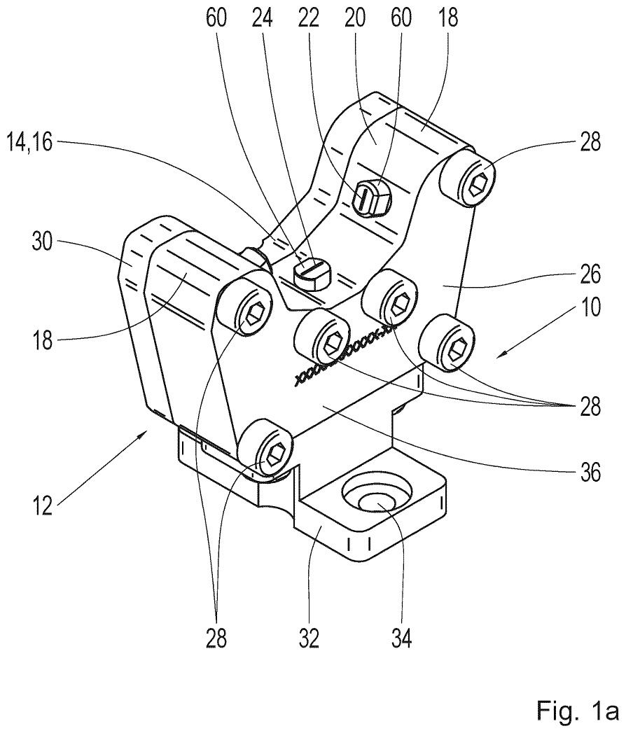

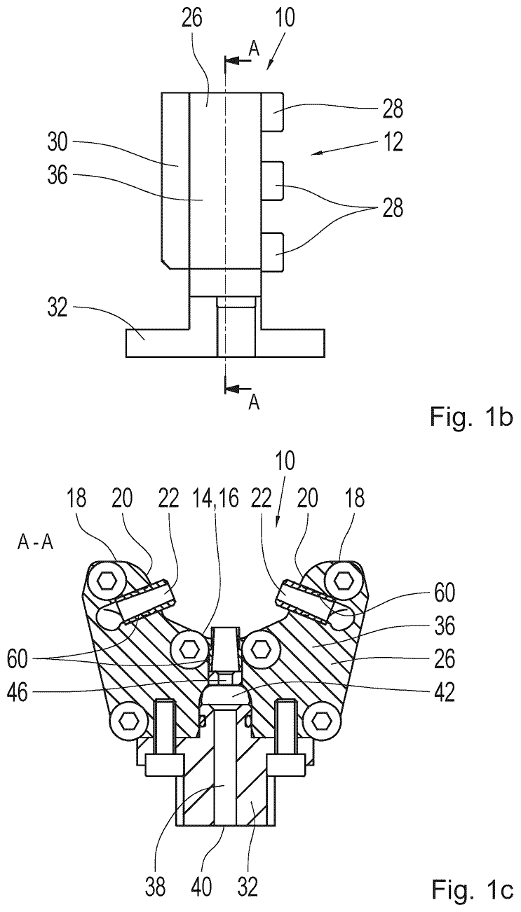

FIG. 1a, b, c a nozzle device in a perspective view, in a side view, and in a sectional representation along the line A-A according to FIG. 1 b, and

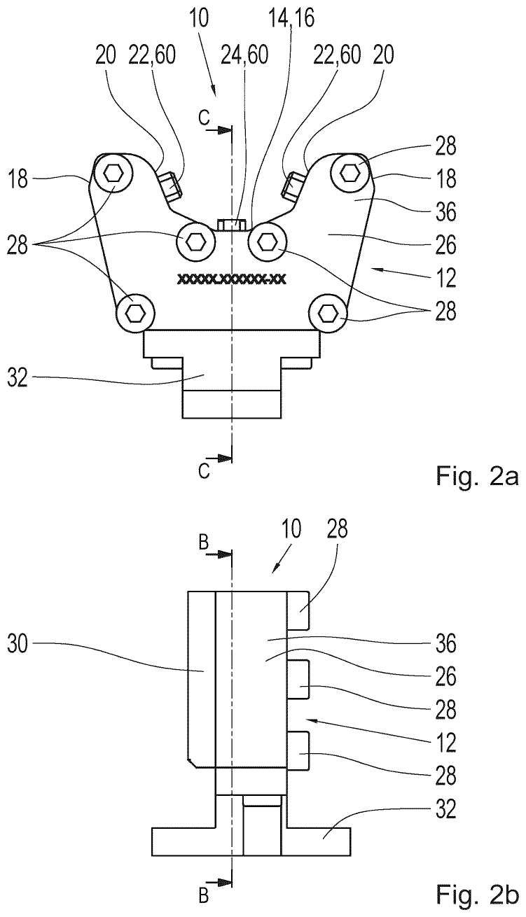

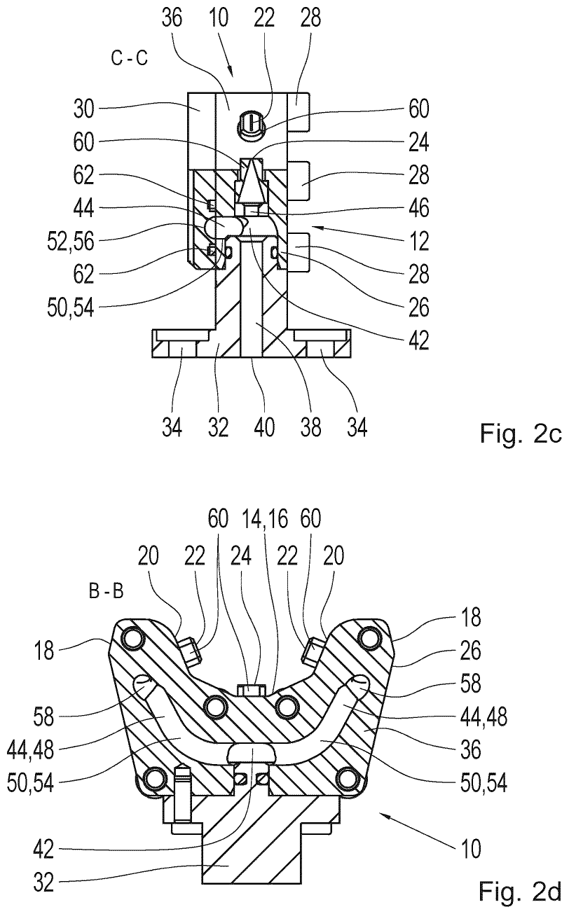

FIG. 2 a to d the nozzle device according to FIG. 1a to c in a first side view, in a second side view, in a sectional representation along the line C-C according to FIG. 2a and in a sectional representation along the line B-B according to FIG. 2b.

The nozzle device 10 shown in the drawing has a nozzle body 12 that has a central part 14 having an end face 16, as well as two side parts 18 that project away from the central part 14 at a distance from one another, which side parts each have a transverse side 20 that runs transverse to the end face 16. The transverse sides 20 face one another at a distance from one another. An exit opening 22 for viscous material is arranged in each of the transverse sides 20, while a further exit opening 24 for the viscous material is arranged in the end face 16. The nozzle body 12 is structured in multiple parts, having a main body 26 and a cover body 30 that is releasably attached to the main body 26 by means of screws 28. The main body 26 in turn is also structured in multiple parts, having a base 32, which has screw holes 34 for being attached to a tool holder, and having an end piece 36 that is releasably connected to the base 32, in which end piece the exit openings 22 and the further exit opening 24 are arranged.

A central channel 38 leads through the base 32 from a material entry opening 40 all the way to a distributor point 42, at which it branches off into two material channels 44 and a further material channel 46, wherein the material channels 44 each lead to one of the exit openings 22, while the further material channel 46 leads to a further exit opening 24. A first section 48 of each of the material channels 44, which section extends starting from the distributor point 42, is delimited, in this regard, by a delimitation surface 50 of the main body 26 on the one side, and by a delimitation surface 52 of the cover body 30 on the other side. The first sections 48 of the material channels 44 are formed, in this regard, by means of a first contour 54 milled into the main body 26 and a second contour 56 milled into the cover plate 30. Starting from each of the first sections 48, a second section 58 of the corresponding material channel 44 extends to the related exit opening 22, which section is drilled into the main body 26 at a slant, starting from the first section 48. In this regard, the further material channel 46 can be drilled into the main body 26 in two stages, namely with a greater diameter starting from the distributor point 42 and with a smaller diameter starting from the end face 16.

The exit openings 22 and the further exit opening 24 are each arranged in a nozzle insert 60 composed of hard metal, which is inserted into the main body 26 and connected to the main body 26 by means of a glued connection, wherein each of the nozzle inserts 60, in the exemplary embodiment shown here, has the same construction, with a piece projecting far out of the main body 26 and a cross-section narrowing toward the corresponding exit opening 22, 24. By means of the narrowing of the cross-section, a better distribution of the material onto the workpiece is achieved. However, it is also possible to configure the nozzle inserts 60 in different ways. Each of the exit openings 22 as well as the further exit opening 24 is/are configured as a flat-stream nozzle having a rectangular cross-section, the longitudinal side of which, extending in the plane of the drawing in the drawing, is five to ten times as long as the transverse side that extends perpendicular to the plane of the drawing in the drawing. Running around the delimitation surfaces 50, 52 and the contours 54, 56, furthermore a sealing element 62 composed of an elastomer material or of metal is arranged between the main body 26 and the cover body 30, which element prevents an undesirable exit of material through a possible gap between the main body 26 and the cover body 30. The sealing element 62 is adapted, in terms of its shape, to the geometry of the delimitation surfaces 50, 52 and the contours 54, 56.

In summary, the following should be stated: The invention relates to a nozzle device 10 for applying a viscous material to workpieces, having a nozzle body 12 that has a central part 14 having an end face 16 and two side parts 18 that project away from the central part 14, at a distance from one another, wherein each of the side parts 18 has a transverse side 20 that follows the end face 16 and runs transverse to it, wherein the two transverse sides 20 face one another, wherein an exit opening 22 for the viscous material is arranged in each of the transverse sides 20, and wherein a material channel 44 runs through the nozzle body 12 to each exit opening 22, which channel connects the exit openings 22 to a material entry opening 40 of the nozzle body 12. According to the invention, it is provided that the nozzle body 12 has a main body 26 and a cover body 30 that is releasably attached to the main body 26, wherein the material channels 44 are delimited, at least section by section, both by a delimitation surface 50 on the main body 26 and by a delimitation surface 52 on the cover body 30.

1. A nozzle device for applying a viscous material to workpieces, having a nozzle body (12) that has a central part (14) having an end face (16) and two side parts (18) that project away from the central part (14), at a distance from one another, wherein each of the side parts (18) has a transverse side (20) that follows the end face (16) and runs transverse to the end face (16), wherein the two transverse sides (20) face one another, wherein an exit opening (22) for the viscous material is arranged in each transverse side (20), and wherein a material channel (44) runs through the nozzle body (12) to each exit opening (22) and connects the exit openings (22) to a material entry opening (40) of the nozzle body (12), wherein the nozzle body (12) has a main body (26) and a cover body (30) that is releasably attached to the main body (26), wherein the material channels (44) are delimited, at least section by section, both by a delimitation surface (50) on the main body (26) and by a delimitation surface (52) on the cover body (30).

2. The nozzle device according to claim 1, wherein a further exit opening (24) for the viscous material is arranged in the end face (16), and connected to the material entry opening (40) a further material channel

3. The nozzle device according to claim 1, wherein the exit openings (22) are arranged with mirror symmetry with reference to a plane of symmetry, which runs, in particular, through the further exit opening (24).

4. The nozzle device according to claim 1, wherein a central channel (38) extends, starting from the material entry opening (40), through the nozzle body (12), and opens into the material channels (22) and, if applicable, into the further material channel (24).

5. The nozzle device according to claim 2, wherein the central channel (38) and the further material channel (24) have a common center longitudinal axis.

6. The nozzle device according to claim 4, wherein the central channel (38) is arranged in the main body (26).

7. The nozzle device according to claim 1, wherein the exit openings (22) and/or the material entry opening (40) and/or, if applicable, the further exit opening (24) is/are arranged in or on the main body (26) and/or wherein, if applicable, the further material channel (46) is arranged in the main body (26).

8. The nozzle device according to claim 1, wherein the material channels (44) each have a first section (48) and a second section (58) that follows the first section (48) in the flow direction of the material, wherein the first sections (48) are delimited, in each instance, by the delimitation surfaces (50, 52) on the main body (26) and on the cover body (30), while the second sections (58) are delimited, in each instance, only by the main body (26).

9. The nozzle device according to claim 1, wherein the cross-section of the central channel (38) is greater than the sum of the cross-sections of the exit openings (22) and, if applicable, the further exit opening (24).

10. The nozzle device according to claim 1, wherein the exit openings (22) and, if applicable, the further exit opening (24) each have a rectangular cross-section, the length of which is at least five times and preferably at least ten times as great as its width.

11. The nozzle device according to claim 10, wherein the center planes that run parallel to the longitudinal sides of the exit openings (22) and, if applicable, the further exit opening (24) and stand perpendicular on the corresponding cross-section lie in a common plane in space.

12. The nozzle device according to claim 1, wherein the exit openings (22) and, if applicable, the further exit opening (24) are each arranged in a nozzle insert (60) that is connected to the nozzle body (12).

13. The nozzle device according to claim 12, wherein the nozzle inserts (60) are produced from hard metal, at least on their inner side that faces the viscous material.

14. The nozzle device according to claim 1, wherein a sealing element (62) is arranged between the main body (26) and the cover body (30) and forms an edge around the delimitation surfaces (50, 52) on the main body (26) and on the cover body (30) that delimit the material channels (22).

15. A method for the production of the nozzle device (10) according to claim 1, the material channels (44) of which each have a first section (48) and a second section (58) that follows the first section (48) in the flow direction of the material, wherein the first sections (48) each are delimited both by a delimitation surface (50) on the main body (26) and by a delimitation surface (52) on the cover body (30), while the second sections (58) are delimited only by the main body (26), wherein the first sections (48) are milled into the main body (26) and/or into the cover body (30) and wherein the second sections (58) are drilled into the main body (26).
